(19) United States
(12) Patent Application Publication
(10) Pub. No.: US 2025/0319726 A1
(43) Pub. Date: Oct. 16, 2025

(54) TIRE

(71) Applicant: Sumitomo Rubber Industries, Ltd., Hyogo (JP)

(72) Inventor: Shinsuke YUKAMI, Kobe-shi (JP)

(73) Assignee: Sumitomo Rubber Industries, Ltd., Hyogo (JP)

(21) Appl. No.: 19/177,044

(22) Filed: Apr. 11, 2025

(30) Foreign Application Priority Data
Apr. 15, 2024 (JP) 2024-065741

(51) Int. Cl. B60C 11/01

(52) U.S. Cl. CPC B60C 11/01; B60C 2011/013

(57) ABSTRACT

A tire 1 includes a first shoulder block 5. The first shoulder block 5 includes a first portion 7 that includes a first tread surface 11 forming a first tread end T1 and a first side wall surface 12 extending inward in a tire radial direction from the first tread end T1, and a second portion 8 that includes a second tread surface 15 forming a second tread end T2 and a second side wall surface 16 extending inward in the tire radial direction from the second tread end T2. The second tread surface 15 includes a recessed portion 18 which is at least partially recessed inward of the first tread surface 11 in the tire radial direction such that the second tread end T2 is located inward of the first tread end T1 in the tire radial direction. A recess 19 is formed in the second side wall surface 16. The recess 19 extends in a tire circumferential direction from a shoulder lateral groove 3, and has a bottom portion 20 in the first shoulder block 5.

### BACKGROUND OF THE INVENTION

### Field of the Invention

The present disclosure relates to a tire.

### Background Art

Japanese Laid-Open Patent Publication No. 2021-003948 discloses a pneumatic tire in which side protectors are provided to sidewall portions in a tire circumferential direction. The side protectors include first protectors each provided with a first inclined groove portion inclined in a first direction, and second protectors each provided with a second inclined groove portion inclined in a second direction. The pneumatic tire exerts excellent off-road performance on muddy terrain.

In recent years, improvement of not only mud performance which is running performance on muddy terrain, but also wet performance and heat durability is required.

The present disclosure has been made in view of the above circumstances, and a main object of the present disclosure is to provide a tire capable of improving mud performance, wet performance, and heat durability.

### SUMMARY OF THE INVENTION

A tire including a tread portion, wherein a plurality of shoulder lateral grooves and a plurality of shoulder blocks demarcated by the plurality of shoulder lateral grooves are formed in the tread portion, the plurality of shoulder blocks include at least one first shoulder block, the first shoulder block includes a first portion including a first tire circumferential end and a second portion including a second tire circumferential end, the first portion includes a first tread surface forming a first tread end and a first side wall surface extending inward in a tire radial direction from the first tread end, the second portion includes a second tread surface forming a second tread end and a second side wall surface extending inward in the tire radial direction from the second tread end, the second tread surface includes a recessed portion which is at least partially recessed inward of the first tread surface in the tire radial direction such that the second tread end is located inward of the first tread end in the tire radial direction, a recess hollowed inward in a tire axial direction is formed in the second side wall surface, and the recess extends in a tire circumferential direction from one shoulder lateral groove adjacent to the second side wall surface, among the plurality of shoulder lateral grooves, and has a bottom portion in the first shoulder block.

As a result of adopting the above-described configuration, the present disclosure can improve mud performance, wet performance, and heat durability.

### BRIEF DESCRIPTION OF THE DRAWINGS

FIG. 1 is a tire meridional cross-sectional view of a tread portion of a tire according to an embodiment of the present disclosure;

FIG. 2 is a partial development view of the tread portion of the tire in FIG. 1;

FIG. 3 is a perspective cross-sectional view of the tread portion shown in FIG. 2;

FIG. 4 is an enlarged view of a portion around a first tread end T1 in FIG. 1;

FIG. 5A is a cross-sectional view taken along a line A-A in FIG. 2, and FIG. 5B is a cross-sectional view taken along a line B-B in FIG. 6;

FIG. 6 is a partial development view of the tread portion of the tire in FIG. 1; and

FIG. 7 is a perspective cross-sectional view of the tread portion shown in FIG. 6.

### DETAILED DESCRIPTION

Hereinafter, an embodiment of the present disclosure will be described with reference to the drawings.

The drawings contain exaggerated expressions and expressions that differ from the dimensional ratio of the actual structure in order to help the understanding of the present disclosure. In addition, when there are a plurality of embodiments, the same or common elements are denoted by the same reference characters throughout the description, and the redundant description thereof is omitted.

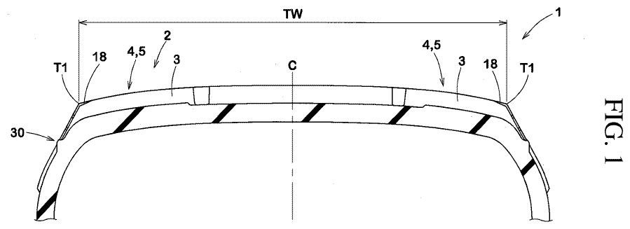

FIG. 1 is a tire meridional cross-sectional view of a tread portion 2 of a tire 1 according to an embodiment of the present disclosure. The present disclosure is suitably used for a pneumatic tire for a passenger car (SUV) capable of running on a muddy road surface, for example. The present disclosure may be adopted for a heavy duty pneumatic tire and also a non-pneumatic tire the interior of which is not filled with pressurized air, for example.

In FIG. 1, the tire 1 in a standardized state is shown. The “standardized state” is a state where the tire 1 is fitted on a standardized rim (not shown) and inflated to a standardized internal pressure and no load is applied to the tire 1. In the present specification, unless otherwise specified, dimensions and the like of components of the tire 1 are values measured in a standardized state.

The “standardized rim” is a rim that is defined, in a standard system including a standard on which the tire is based, by the standard for each tire, and is, for example, the “standard rim” in the JATMA standard, the “Design Rim” in the TRA standard, or the “Measuring Rim” in the ETRTO standard.

The “standardized internal pressure” is an air pressure that is defined, in a standard system including a standard on which the tire is based, by the standard for each tire, and is the “maximum air pressure” in the JATMA standard, the maximum value indicated in the table “TIRE LOAD LIMITS AT VARIOUS COLD INFLATION PRESSURES” in the TRA standard, or the “INFLATION PRESSURE” in the ETRTO standard.

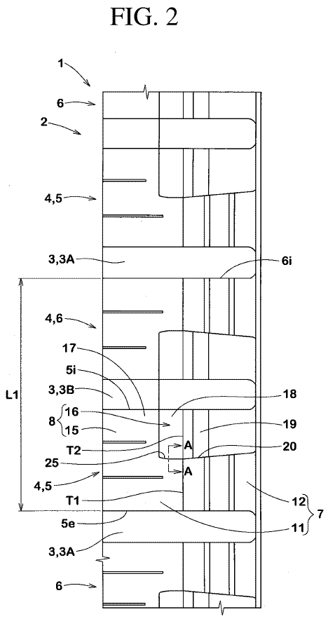

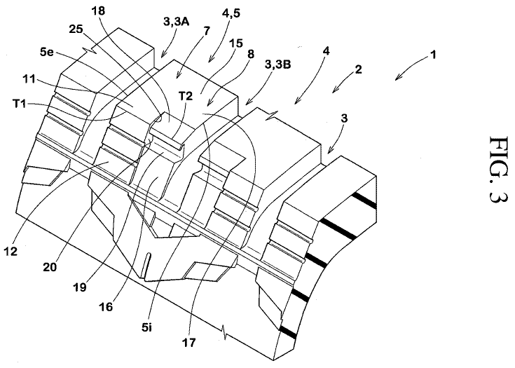

FIG. 2 is a partial development view of the tread portion 2 of the tire 1 in FIG. 1. FIG. 3 is a perspective cross-sectional view of the tread portion 2 shown in FIG. 2. As shown in FIG. 1 to FIG. 3, a plurality of shoulder lateral grooves 3, and a plurality of shoulder blocks 4 demarcated by the plurality of shoulder lateral grooves 3 are formed in the tread portion 2 of the present embodiment. The shoulder lateral grooves 3 of the present embodiment are provided at both sides in a tire circumferential direction of each shoulder block 4. In the present specification, the “groove” refers to a recess-shaped portion having a groove width of 1.5 mm or more, and is distinguished from a sipe having a width of less than 1.5 mm.

The plurality of shoulder blocks 4 include at least one first shoulder block 5. The first shoulder block 5 includes a first portion 7 including a first tire circumferential end 5e and a second portion 8 including a second tire circumferential end 5i. Each of the first tire circumferential end 5e and the second tire circumferential end 5i is formed as a block edge of the first shoulder block 5. The first tire circumferential end 5e and the second tire circumferential end 5i are adjacent to the shoulder lateral grooves 3, respectively, and extend in a tire axial direction. As described above, in the present embodiment, the shoulder lateral grooves 3 include a first shoulder lateral groove 3A adjacent to the first tire circumferential end 5e and a second shoulder lateral groove 3B adjacent to the second tire circumferential end 5i.

The first portion 7 includes a first tread surface 11 forming a first tread end T1, and a first side wall surface 12 extending inward in a tire radial direction from the first tread end T1. The second portion 8 includes a second tread surface 15 forming a second tread end T2, and a second side wall surface 16 extending inward in the tire radial direction from the second tread end T2. In the present specification, the first tread end T1 represents an outermost ground contact position in the tire axial direction in a standardized load applied state where a standardized load is applied to the tire 1 in the standardized state and the tire 1 is in contact with a plane at a camber angle of 0 degrees.

The “standardized load” is a load that is defined, in a standard system including a standard on which the tire is based, by the standard for each tire, and is the “maximum load capacity” in the JATMA standard, the maximum value indicated in the table “TIRE LOAD LIMITS AT VARIOUS COLD INFLATION PRESSURES” in the TRA standard, or the “LOAD CAPACITY” in the ETRTO standard.

A recess 19 hollowed inward in the tire axial direction is formed in the second side wall surface 16. The recess 19 extends in the tire circumferential direction from one (second shoulder lateral groove 3B) adjacent to the second side wall surface 16, among the plurality of shoulder lateral grooves 3, and has a bottom portion 20 in the first shoulder block 5. As described above, the recess 19 is formed in a closed shape within the second side wall surface 16. Such a recess 19 exerts a great shearing force on mud during running on muddy terrain.

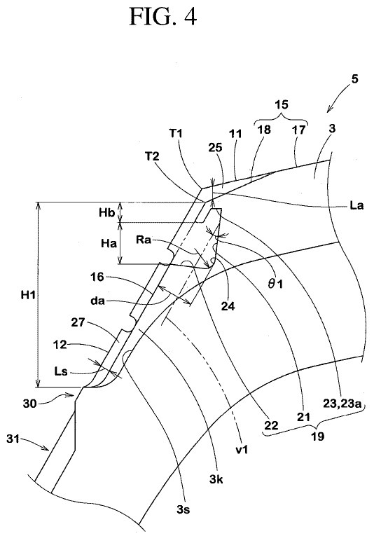

FIG. 4 is an enlarged view of a portion around the first tread end T1 in FIG. 1. As shown in FIG. 2 to FIG. 4, the second tread surface 15 includes a recessed portion 18 which is at least partially recessed inward of the first tread surface 11 in the tire radial direction such that the second tread end T2 is located inward of the first tread end T1 in the tire radial direction. Such a recessed portion 18 exerts a shearing force on mud between the recessed portion 18 and the first tread surface 11 during running on muddy terrain.

The second tread end T2 is, for example, a position that is not in contact with the plane in the standardized load applied state. Such a second tread end T2 allows a further increased groove volume of an outer side portion of the shoulder lateral groove 3, so that wet performance is further enhanced. In this case, an end, in the tire axial direction, that is in contact with the plane in the standardized load applied state is formed on the recessed portion 18. The second tread end T2 may be a position that is in contact with the plane in the standardized load applied state.

In addition, the recessed portion 18 is connected to the second shoulder lateral groove 3B. Such a recessed portion 18 allows an increased groove volume of the outer side portion of the shoulder lateral groove 3, so that mud and water in the shoulder lateral groove 3 can be smoothly expelled. Further, the recess 19 and the recessed portion 18 allow an increased surface area of the first shoulder block 5, so that its heat dissipation effect can be enhanced. Therefore, the tire 1 of the present disclosure is excellent in mud performance, wet performance, and heat durability.

The second tread surface 15 of the present embodiment includes the recessed portion 18, and a main portion 17 extending inward in the tire axial direction from the recessed portion 18. The main portion 17 is, for example, smoothly connected to the first tread surface 11 in the tire circumferential direction.

The first tread surface 11 and the recessed portion 18 of the second tread surface 15 are connected to each other via a step surface 25. The step surface 25, for example, extends in the tire radial direction and the tire axial direction. Such a step surface 25 exerts a great shearing force on mud during running on muddy terrain.

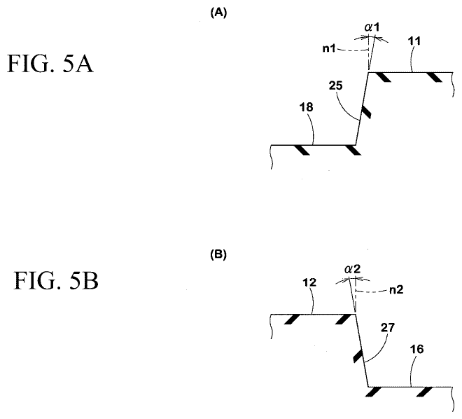

FIG. 5A is a cross-sectional view taken along a line A-A in FIG. 2. As shown in FIG. 5A, the step surface 25 is inclined relative to a normal line n1 that is normal to the first tread surface 11, which is erected at a position at which the step surface 25 and the first tread surface 11 meet with each other. Accordingly, the surface area of the step surface 25 is increased, and heat durability is improved. If an angle α1 between the normal line n1 and the step surface 25 becomes too large, a shearing force due to the step surface 25 may decrease. Thus, the angle α1 is preferably 2 degrees or more and further preferably 5 degrees or more, and is preferably 15 degrees or less and further preferably 13 degrees or less.

As shown in FIG. 4, a separation distance La in the tire radial direction between the first tread surface 11 and the recessed portion 18 continuously increases toward the second tread end T2 side. Such a recessed portion 18 allows mud and water in the recessed portion 18 to be smoothly expelled to the outside via the second tread end T2.

The separation distance La is preferably 5% or less of a tread width TW (shown in FIG. 1). If the separation distance La exceeds 5% of the tread width TW, the ground-contact surface of the first shoulder block 5 becomes small, and wet performance may deteriorate. In order to improve mud performance and wet performance, the maximum value of the separation distance La is, for example, preferably 1% or more and further preferably 2% or more of the tread width TW.

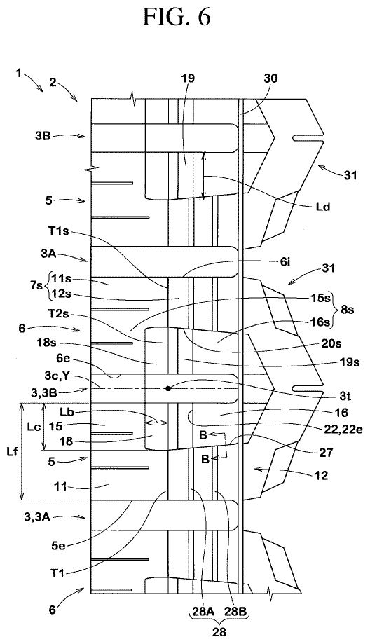

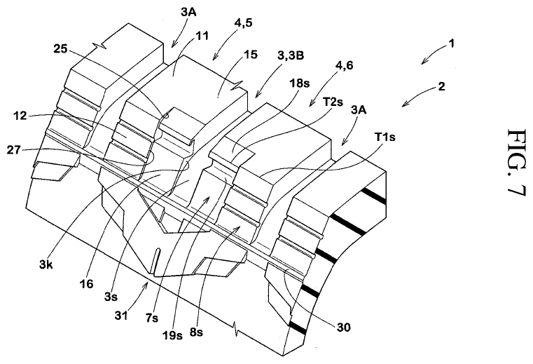

FIG. 6 is a partial development view of the tread portion 2 of the tire 1 in FIG. 1. FIG. 7 is a perspective cross-sectional view of the tread portion 2 shown in FIG. 6. As shown in FIG. 4, FIG. 6, and FIG. 7, a length Lb in the tire axial direction of the recessed portion 18 is preferably 15% or more and further preferably 20% or more, and is preferably 30% or less and further preferably 25% or less, of a length Lf in the tire circumferential direction of the first shoulder block 5. Since the length Lb is 15% or more of the length Lf, water on the first tread surface 11 and water on the second tread surface 15 can be smoothly expelled. Since the length Lb is 30% or less of the length Lf, the stiffness of the first shoulder block 5 can be maintained high. In the present specification, the length Lf is the maximum length of the first shoulder block 5, taken over the recessed portion 18. From the same viewpoint, a length Lc in the tire circumferential direction of the recessed portion 18 is preferably 20% or more and further preferably 30% or more, and is preferably 80% or less and further preferably 70% or less, of the length Lf of the first shoulder block 5.

The second side wall surface 16 is located inward of the first side wall surface 12 in the tire axial direction. As described above, in the present embodiment, the second side wall surface 16 and the first side wall surface 12 are connected to each other via a side wall step surface 27. Such a side wall step surface 27 also exhibits a shearing force on mud during running on muddy terrain. The tire 1 of the present disclosure is not limited to a mode of being provided with the side wall step surface 27, and the first side wall surface 12 and the second side wall surface 16 may be smoothly connected to each other so as to form one surface.

In the present embodiment, the side wall step surface 27 and the step surface 25 are smoothly connected to each other so as to form one surface. Thus, mud caught in the recessed portion 18 can be smoothly expelled to the second side wall surface 16 side.

FIG. 5B is a cross-sectional view taken along a line B-B in FIG. 6. As shown in FIG. 5B, the side wall step surface 27 is inclined relative to a normal line n2 that is normal to the first side wall surface 12, which is erected at a position at which the side wall step surface 27 and the first side wall surface 12 meet with each other. Accordingly, the surface area of the side wall step surface 27 is increased, and heat durability is improved. If an angle α2 between the normal line n2 and the side wall step surface 27 becomes too large, a shearing force due to the side wall step surface 27 may decrease. Thus, the angle α2 is preferably 2 degrees or more and further preferably 5 degrees or more, and is preferably 15 degrees or less and further preferably 13 degrees or less.

As shown in FIG. 4, a separation distance Ls between the first side wall surface 12 and the second side wall surface 16 is preferably 1 mm or more and further preferably 5 mm or more, and is preferably 15 mm or less and further preferably 10 mm or less. Since the separation distance Ls is 1 mm or more, a shearing force on mud due to the second side wall surface 16 can be exerted. Since the separation distance Ls is 15 mm or less, damage to the first side wall surface 12 can be inhibited. In the present specification, the separation distance Ls is a length in a direction normal to the second side wall surface 16.

As shown in FIG. 4 and FIG. 7, the second side wall surface 16 is raised with respect to a groove bottom 3s of the shoulder lateral groove 3 adjacent to the second side wall surface 16. Such a second side wall surface 16 allows an increased surface area of the first shoulder block 5, and serves to improve heat durability. In addition, with such a second side wall surface 16, a groove wall surface 3k is formed between the second side wall surface 16 and the groove bottom 3s of the shoulder lateral groove 3, and the groove wall surface 3k exerts a shearing force on mud during running on muddy terrain.

The recess 19 includes an outward surface 21 facing outward in the tire axial direction. On a tire meridional cross section passing through the outward surface 21, an angle θ1 between the outward surface 21 and the second side wall surface 16 is preferably 45 degrees or more and further preferably 60 degrees or more, and is preferably 120 degrees or less and further preferably 90 degrees or less. Since the angle θ1 is 45 degrees or more and 120 degrees or less, a large volume of the recess 19 is ensured, and the stiffness of the first shoulder block 5 in the vicinity of the recess 19 is maintained high. A virtual line v1 shown in FIG. 4 is a line segment parallel to the second side wall surface 16. For convenience, the angle θ1 is indicated by an angle between the virtual line v1 and the outward surface 21.

The recess 19 further includes an inner surface 22 connecting the outward surface 21 to the second side wall surface 16, and an outer surface 23 located outward of the inner surface 22 in the tire radial direction and connecting the outward surface 21 to the second side wall surface 16. The inner surface 22, for example, faces outward in the tire radial direction and extends in the tire axial direction. The outer surface 23 is, for example, formed so as to include a recessed surface 23a that is recessed outward in the tire radial direction. Such an outer surface 23 increases the amount of mud to be caught in the recess 19, and its shearing force can be increased. The outer surface 23 is not limited to such a mode, and, for example, may face inward in the tire radial direction and extend substantially parallel to the inner surface 22 (not shown).

In the present embodiment, the outward surface 21 and the inner surface 22 of the recess 19 are connected to each other via an arc 24. A radius of curvature Ra of the arc 24 is preferably 1 mm or more and further preferably 2 mm or more, and is preferably 10 mm or less and further preferably 8 mm or less. With such a recess 19, the stiffness of the first shoulder block 5 is maintained high.

As shown in FIG. 4 or FIG. 6, a length Ld in the tire circumferential direction of the recess 19 is preferably 20% or more and further preferably 30% or more, and is preferably 80% or less and further preferably 70% or less, of the length Lf of the first shoulder block 5. The length Ld is the maximum length in the tire circumferential direction of the recess 19, taken along the second side wall surface 16. From the same viewpoint, a length Ha in the tire radial direction of the recess 19 is preferably 15% or more and further preferably 20% or more, and is preferably 35% or less and further preferably 30% or less, of a length H1 in the tire radial direction of the second side wall surface 16. In addition, a maximum depth da of the recess 19 is preferably 1 mm or more and further preferably 5 mm or more, and is preferably 20 mm or less and further preferably 15 mm or less. Thus, a great shearing force on mud is exerted during running on muddy terrain, and the stiffness of the first shoulder block 5 is maintained, so that stable running on a wet road surface can be achieved. The length Ha is the length of an opening, taken along the second side wall surface 16. The maximum depth da of the recess 19 is measured in the direction normal to the second side wall surface 16.

A length Hb in the tire radial direction between the recess 19 and the second tread end T2 is, but is not particularly limited to, preferably 2 mm or more and further preferably 5 mm or more, and preferably 15 mm or less and further preferably 10 mm or less.

The first side wall surface 12 includes at least one circumferential small groove 28 extending in the tire circumferential direction. The circumferential small groove 28, for example, extends so as to connect the first tire circumferential end 5e (shown in FIG. 2) to the side wall step surface 27. The circumferential small groove 28 of the present embodiment extends parallel to the tire circumferential direction. Such a circumferential small groove 28 can further enhance a shearing force on mud.

In the present embodiment, two circumferential small grooves 28 are provided so as to be spaced from each other in the tire radial direction. The circumferential small grooves 28 include a first circumferential small groove 28A adjacent to the first tread end T1, and a second circumferential small groove 28B located inward of the first circumferential small groove 28A in the tire radial direction. The first circumferential small groove 28A is connected to the recess 19. Thus, mud in the first circumferential small groove 28A can be smoothly expelled via the recess 19. In the present embodiment, the first circumferential small groove 28A is connected to the inner surface 22 of the recess 19.

As shown in FIG. 1, the tread portion 2 of the present embodiment includes the plurality of shoulder lateral grooves 3 and the plurality of shoulder blocks 4, on both end sides in the tire axial direction across a tire equator C. Thus, the tread portion 2 is provided with the first tread end T1 of the first shoulder block 5 on each side in the tire axial direction. In the present specification, the length in the tire axial direction between the first tread ends T1 on the both sides is referred to as tread width TW.

The tread portion 2 includes, for example, a plurality of grooves (not shown) inward of the shoulder block 4 in the tire axial direction, and a plurality of inner blocks (not shown) demarcated by the plurality of grooves. The plurality of grooves and the plurality of inner blocks have various shapes in a conventional manner.

As shown in FIG. 6 and FIG. 7, the plurality of shoulder blocks 4 include at least one second shoulder block 6. The second shoulder block 6 is adjacent to the first shoulder block 5 via the shoulder lateral groove 3. The tread portion 2 of the present embodiment is provided with the first shoulder blocks 5 and the second shoulder blocks 6 arranged alternately in the tire circumferential direction with the shoulder lateral grooves 3 therebetween. In the present embodiment, the first shoulder lateral grooves 3A and the second shoulder lateral grooves 3B are arranged alternately in the tire circumferential direction.

The second shoulder block 6 has a line-symmetrical shape about a groove center line 3c of one (second shoulder lateral groove 3B) of the shoulder lateral grooves 3, with respect to the first shoulder block 5. In the above, “a line-symmetrical shape with respect to the first shoulder block 5” means that the second shoulder block 6 includes a first portion 7s including a second tire circumferential end 6i and a second portion 8s including a first tire circumferential end 6e. As described above, the second portion 8s is located on the groove center line 3c side with respect to the first portion 7s. In addition, “has a line-symmetrical shape with respect to the first shoulder block 5” means that the first portion 7s, for example, includes a first tread surface 11s forming a first tread end T1s and a first side wall surface 12s extending inward in the tire radial direction from the first tread end T1s, and, further, that the second portion 8s, for example, includes a second tread surface 15s forming a second tread end T2s and a second side wall surface 16s extending inward in the tire radial direction from the second tread end T2s.

In addition, “has a line-symmetrical shape with respect to the first shoulder block 5” at least means that the second portion 8s includes the second side wall surface 16s in which a recess 19s is formed, and the second tread surface 15s including a recessed portion 18s. The groove center line 3c is a tire axial line Y passing through a groove width center position 3t of the shoulder lateral groove 3 on a tire circumferential line passing through the first tread end T1.

As shown in FIG. 2 and FIG. 6, the first tread end T1s is, for example, disposed at the same position as the first tread end T1 in the tire axial direction and the tire radial direction. The second tread end T2s is, for example, disposed at the same position as the second tread end T2 in the tire axial direction and the tire radial direction. The first tread surface 11s is, for example, formed so as not to be line-symmetrical with respect to the first tread surface 11. The second tread surface 15s is, for example, formed so as not to be line-symmetrical with respect to the second tread surface 15. The first side wall surface 12s is, for example, formed so as to be line-symmetrical with respect to the first side wall surface 12. The second side wall surface 16s is, for example, formed so as to be line-symmetrical with respect to the second side wall surface 16. The first tread surface 11s may be line-symmetrical with respect to the first tread surface 11, and the second tread surface 15s may be line-symmetrical with respect to the second tread surface 15. Further, the first side wall surface 12s need not be formed so as to be line-symmetrical with respect to the first side wall surface 12. The second side wall surface 16s need not be formed so as to be line-symmetrical with respect to the second side wall surface 16.

The recess 19s formed in the second side wall surface 16s of the present embodiment is hollowed inward in the tire axial direction. The recess 19s extends in the tire circumferential direction from the second shoulder lateral groove 3B adjacent to the second side wall surface 16s, and has a bottom portion 20s in the second shoulder block 6. The recess 19s is, for example, formed so as to be line-symmetrical with respect to the recess 19. Such a recess 19s, together with the recess 19, exerts a shearing force on mud at the time of braking and driving during running on muddy terrain. The recess 19s, for example, need not be formed so as to be line-symmetrical with the recess 19.

As shown in FIG. 6 and FIG. 7, the recessed portion 18s of the second tread surface 15s of the present embodiment is at least partially recessed inward of the first tread surface 11s in the tire radial direction such that the second tread end T2s is located inward of the first tread end T1s in the tire radial direction. Such a recessed portion 18s exerts a great shearing force on mud between the recessed portion 18s and the first tread surface 11s during running on muddy terrain. The recessed portion 18s is, for example, formed so as to be line-symmetrical with the recessed portion 18. The recessed portion 18s need not be formed so as to be line-symmetrical with the recessed portion 18.

In addition, the recessed portion 18s is connected to the second shoulder lateral groove 3B adjacent to the second side wall surface 16s. Such a recessed portion 18s allows an increased groove volume of the outer side portion of the shoulder lateral groove 3, so that mud and water in the shoulder lateral groove 3 can be smoothly expelled. Further, the recess 19s and the recessed portion 18s increase the surface area of the second shoulder block 6, which can enhance its heat dissipation effect.

As shown in FIG. 2 and FIG. 6, the length Lf of the first shoulder block 5 is preferably 20% or more and further preferably 30% or more, and is preferably 60% or less and further preferably 50% or less, of a separation distance L1 in the tire circumferential direction between the first tire circumferential end 5e of the first shoulder block 5 and the second tire circumferential end 6i of the second shoulder block 6. Since the length Lf of the first shoulder block 5 is 20% or more and 60% or less of the separation distance L1, the stiffness in the tire circumferential direction of the first shoulder block 5 is maintained, so that stable mud performance and stable wet performance can be ensured. In the present specification, the separation distance L1 is the maximum length, taken over the recessed portions 18.

As shown in FIG. 4, FIG. 6, and FIG. 7, the tire 1 of the present embodiment is provided with a circumferential protrusion 30 formed inward of the shoulder blocks 4 in the tire radial direction. The circumferential protrusion 30, for example, extends in the tire circumferential direction, and is raised outward in the tire axial direction. The circumferential protrusion 30 of the present embodiment continuously extends in the tire circumferential direction.

The circumferential protrusion 30 is, for example, connected to the shoulder lateral grooves 3 and the shoulder blocks 4. In the present embodiment, the circumferential protrusion 30 connects to the first side wall surfaces 12, 12s and the second side wall surfaces 16, 16s of the shoulder blocks 4. The circumferential protrusion 30 is raised outward in the tire axial direction with respect to the first side wall surfaces 12, 12s. Raised portions 31 are provided inward of the circumferential protrusion 30 in the tire radial direction so as to be arranged in the tire circumferential direction. The raised portions 31 are formed in a V shape so as to be connected to, via the circumferential protrusion 30, the first shoulder block 5 and the second shoulder block 6 adjacent to each other in the tire circumferential direction.

Although the particularly preferred embodiment of the present disclosure has been described above in detail, the present disclosure is not limited to the illustrated embodiment, and various modifications can be made to implement the present disclosure.

### [Additional Note]

The present disclosure includes the following aspects.

### [Present Disclosure 1]

A tire including a tread portion, wherein
a plurality of shoulder lateral grooves, and a plurality of shoulder blocks demarcated by the plurality of shoulder lateral grooves are formed in the tread portion,
the plurality of shoulder blocks include at least one first shoulder block,
the first shoulder block includes a first portion including a first tire circumferential end and a second portion including a second tire circumferential end,
the first portion includes a first tread surface forming a first tread end and a first side wall surface extending inward in a tire radial direction from the first tread end,
the second portion includes a second tread surface forming a second tread end and a second side wall surface extending inward in the tire radial direction from the second tread end,
the second tread surface includes a recessed portion which is at least partially recessed inward of the first tread surface in the tire radial direction such that the second tread end is located inward of the first tread end in the tire radial direction,
a recess hollowed inward in a tire axial direction is formed in the second side wall surface, and
the recess extends in a tire circumferential direction from one shoulder lateral groove adjacent to the second side wall surface, among the plurality of shoulder lateral grooves, and has a bottom portion in the first shoulder block.

### [Present Disclosure 2]

The tire according to Present Disclosure 1, wherein
the plurality of shoulder blocks include at least one second shoulder block,
the second shoulder block is adjacent to the first shoulder block via one of the plurality of shoulder lateral grooves, and
the second shoulder block has a line-symmetrical shape about a groove center line of one of the shoulder lateral grooves, with respect to the first shoulder block.

### [Present Disclosure 3]

The tire according to the present disclosure 2, wherein a length in the tire circumferential direction of the first shoulder block is 20% to 60% of a separation distance in the tire circumferential direction between the first tire circumferential end of the first shoulder block and a second tire circumferential end of the second shoulder block.

### [Present Disclosure 4]

The tire according to any one of Present Disclosures 1 to 3, wherein a separation distance in the tire radial direction between the first tread surface and the recessed portion continuously increases toward the second tread end.

### [Present Disclosure 5]

The tire according to Present Disclosure 4, wherein the separation distance is 5% or less of a tread width.

### [Present Disclosure 6]

The tire according to any one of Present Disclosures 1 to 5, wherein a length in the tire axial direction of the recessed portion is 15% to 30% of the length in the tire circumferential direction of the first shoulder block.

### [Present Disclosure 7]

The tire according to any one of Present Disclosures 1 to 6, wherein
the recess includes an outward surface facing outward in the tire axial direction, and
on a tire meridional cross section passing through the outward surface,
an angle between the outward surface and the second side wall surface is 45 to 120 degrees.

### [Present Disclosure 8]

The tire according to any one of Present Disclosures 1 to 7, wherein the second side wall surface is located inward of the first side wall surface in the tire axial direction.

### [Present Disclosure 9]

The tire according to Present Disclosure 8, wherein a separation distance in the tire axial direction between the first side wall surface and the second side wall surface is 1 mm or more.

### [Present Disclosure 10]

The tire according to any one of Present Disclosures 1 to 9, wherein the second side wall surface is raised with respect to a groove bottom of the shoulder lateral groove adjacent to the second side wall surface.

### [Present Disclosure 11]

The tire according to any one of Present Disclosures 1 to 10, wherein the first tread surface and the recessed portion of the second tread surface are connected to each other via a step surface.

### [Present Disclosure 12]

The tire according to any one of Present Disclosures 1 to 11, wherein a length in the tire circumferential direction of the recessed portion is 20% to 80% of the length in the tire circumferential direction of the first shoulder block.

What is claimed is:

1. A tire comprising:
a tread portion, wherein
a plurality of shoulder lateral grooves, and a plurality of shoulder blocks demarcated by the plurality of shoulder lateral grooves, are in the tread portion,
the plurality of shoulder blocks include at least one first shoulder block,
the first shoulder block includes a first portion including a first tire circumferential end and a second portion including a second tire circumferential end,
the first portion includes a first tread surface configuring a first tread end and a first side wall surface extending inward in a tire radial direction from the first tread end,
the second portion includes a second tread surface configuring a second tread end and a second side wall surface extending inward in the tire radial direction from the second tread end,
the second tread surface includes a recessed portion which is at least partially recessed inward of the first tread surface in the tire radial direction such that the second tread end is inward of the first tread end in the tire radial direction,
a recess hollowed inward in a tire axial direction is in the second side wall surface, and
the recess extends in a tire circumferential direction from one shoulder lateral groove adjacent to the second side wall surface, among the plurality of shoulder lateral grooves, and has a bottom portion in the first shoulder block.

2. The tire according to claim 1, wherein
the plurality of shoulder blocks include at least one second shoulder block,
the second shoulder block is adjacent to the first shoulder block via one of the plurality of shoulder lateral grooves, and
the second shoulder block has a line-symmetrical shape about a groove center line of one of the shoulder lateral grooves, with respect to the first shoulder block.

3. The tire according to claim 2, wherein
a length in the tire circumferential direction of the first shoulder block is 20% to 60% of a separation distance in the tire circumferential direction between the first tire circumferential end of the first shoulder block and a second tire circumferential end of the second shoulder block.

4. The tire according to claim 1, wherein
a separation distance in the tire radial direction between the first tread surface and the recessed portion continuously increases toward the second tread end.

5. The tire according to claim 4, wherein
the separation distance is 5% or less of a tread width.

6. The tire according to claim 1, wherein
a length in the tire axial direction of the recessed portion is 15% to 30% of a length in the tire circumferential direction of the first shoulder block.

7. The tire according to claim 1, wherein
the recess includes an outward surface facing outward in the tire axial direction, and
on a tire meridional cross section passing through the outward surface, an angle between the outward surface and the second side wall surface is 45 to 120 degrees.

8. The tire according to claim 1, wherein
the second side wall surface is inward of the first side wall surface in the tire axial direction.

9. The tire according to claim 8, wherein
a separation distance between the first side wall surface and the second side wall surface is 1 mm or more.

10. The tire according to claim 1, wherein
the second side wall surface is raised with respect to a groove bottom of the shoulder lateral groove adjacent to the second side wall surface.

11. The tire according to claim 1, wherein
the first tread surface and the recessed portion of the second tread surface are connected to each other via a step surface.

12. The tire according to claim 1, wherein
a length in the tire circumferential direction of the recessed portion is 20% to 80% of a length in the tire circumferential direction of the first shoulder block.
